(19) United States
(12) Patent Application Publication
(10) Pub. No.: US 2024/0273617 A1
(43) Pub. Date: Aug. 15, 2024

(54) TRACTOR OPERATION OR STATUS MONITORING AND ALERT SYSTEM SUITED FOR FACILITATING LEASE FINANCING, AND RELATED METHOD

(71) Applicant: Tradition Leasing Systems, L.L.C., Indianapolis, IN (US)

(72) Inventors: Joseph Montel, Indianapolis, IN (US); Isaac Fleetwood, Indianapolis, IN (US)

(21) Appl. No.: 18/109,486

(22) Filed: Feb. 14, 2023

(51) Int. Cl. G06Q 30/0645; G06Q 10/20; G06Q 40/08

(52) U.S. Cl. CPC G06Q 30/0645; G06Q 10/20; G06Q 40/08

(57) ABSTRACT

The present disclosure relates to systems and methods for facilitating the lease financing of tractors for tractor-trailers. In one example embodiment, a tractor operation or status monitoring and alert system suited for facilitating lease financing of tractors includes at least one equipment leasing company computer including a front end server, a back end server, and a database, a first financial institution computer, a dispatching company computer, a lessee computer including a mobile device or a desktop or laptop computer; a servicing company computer, an additional computer including at least one cloud server, and one or more wired or wireless communication links. The at least one equipment leasing company computer is configured to send a first report for receipt by the first financial institution computer and, if it is determined that a first leased tractor has failed to meet a first requirement, to send at least one alert or notification.

### CROSS-REFERENCE TO RELATED APPLICATIONS

--

### FIELD OF THE INVENTION

The present invention relates to systems and methods for facilitating lease financing, and more particularly relates to such systems and methods that facilitate lease financing with respect to tractors for tractor-trailers.

### BACKGROUND OF THE INVENTION

Lease financing is a well-established platform for financial institutions and, in the context of the trucking industry, lease financing of tractors for tractor-trailers (or semi-trailer trucks or semi-tractors) is commonly employed as a financial mechanism by which drivers can gain access to tractors notwithstanding the high cost of those tractors (e.g., $225,000 per tractor). These leases are considered functional equivalents of loans, must be full-payout leases, and are subject to lending limits generally (same rules as loans). A “full-payout lease” is a lease in regard to which a national bank reasonably expects to realize its full investment in the leased property (and financing costs) from rentals, the estimated tax benefits, and the estimated residual value of the property at the expiration of the lease term.

Although lease financing programs are commonly employed in the context of leasing tractors for tractor-trailers, conventional business practices of this type face various challenges. Federal leasing regulations (49 C.F.R. Part 376) are unique in the transportation sector and inhibit conventional financing and monitoring (both lending and lease financing) by requiring carriers using owner operators, which owner operators finance or lease their equipment (e.g., tractor-trailers or semi-tractors), to enter into written lease agreements whereby the owner operator who owns or leases their equipment leases the equipment to the carrier, and the carrier then enters into a written agreement leasing the equipment to the owner operator. Tracking and measuring financial and related data becomes impaired by the tiers of leases and limitations of the transportation software currently in the market. Indeed, lease agreements typically set forth various requirements that need to be met during the time of the lease, while accounting for the rapid termination and re-leasing of equipment between the carrier and the driver. Such requirements can include, for example, obligations to provide the lessor with information regarding the status of the leased tractor, including the location and the maintenance status of the leased tractor. In conventional leasing arrangements, satisfying such requirements can be difficult to meet with sufficient efficiency, accuracy, frequency, or rapidity.

For at least one or more of these reasons, or one or more other reasons, it would be advantageous if new or improved systems and methods for conducting or facilitating lease financing with respect to tractors for tractor-trailers could be developed.

### SUMMARY OF THE INVENTION

The present disclosure is intended to encompass a variety of embodiments of systems and methods that relate to or facilitate the lease financing of tractors for tractor-trailers.

In at least some example embodiments, the present disclosure relates to a tractor operation or status monitoring and alert system suited for facilitating lease financing of tractors for tractor-trailers. The system includes at least one equipment leasing company computer including a front end server, a back end server, and a database, a first financial institution computer, a dispatching company computer, a lessee computer including a mobile device or a desktop or laptop computer, a servicing company computer, and an additional computer including at least one cloud server. The system also includes one or more wired or wireless communication links by which the at least one equipment leasing company computer is at least indirectly in communication with each of the financial institution computer, the dispatching company computer, the lessee computer, the servicing company computer, and the additional computer.

Further, the at least one equipment leasing company computer is configured to receive first information regarding either an operation or a status of a first leased tractor at the database, the first information being received from the at least one cloud server and based at least indirectly upon second information obtained by one or more sensing devices supported on or associated with a first leased tractor. Also, the at least one equipment leasing company computer is configured to perform first processing in regard to the first information to generate first processed information that includes a first report regarding the first leased tractor, and to send the first report for receipt by the first financial institution computer.

Additionally, the at least one equipment leasing company computer is configured to determine, at least in part based upon the first information, the second information, or third information, whether the first leased tractor has failed to meet a first requirement of a first agreement pertaining to the lease financing of the first leased tractor. Further, the at least one equipment leasing company computer is configured to send at least one alert or notification for receipt by one or more of the first financial institution computer, a second financial institution computer, the dispatching company computer, the lessee computer, the servicing company computer, or the additional computer, if it is determined that the first leased tractor has failed to meet the first requirement.

Additionally, in at least some example embodiments, the present disclosure relates to a tractor operation or status monitoring and alert system suited for facilitating lease financing. The system includes at least one equipment leasing company computer including a front end server, a back end server, and a database. Further, the at least one equipment leasing company computer is configured to engage in internet-based communications with a plurality of other computers including each of a first financial institution computer, a dispatching company computer, a lessee computer, a servicing company computer, and an additional computer including at least one cloud server.

Also, the at least one equipment leasing company computer is programmed to operate in accordance with software so that the at least one equipment leasing company computer is configured to: receive first information regarding operations or statuses of a plurality of leased tractors including a first leased tractor and a second leased tractor by engaging as a client in communications with the at least one cloud server; store the first information in the database, the first information being received from the at least one cloud server and based at least indirectly upon second information obtained by sensing devices and engine control units (ECUs) supported on or associated with the first and second leased tractors with which the at least one cloud server is at least indirectly in communication; perform first processing in regard to the first information to generate first processed information that includes a first report regarding the first leased tractor and a second report regarding the second leased tractor; send the first and second reports for receipt by the first financial institution computer; determine, at least in part based upon the first information or second information, whether the first leased tractor has failed to meet a first requirement of a first agreement pertaining to the lease financing of the first leased tractor; and, if it is determined that the first leased tractor has failed to meet the first requirement, send at least one alert or notification for receipt by one or more of the first financial institution computer, a second financial institution computer, the dispatching company computer, the lessee computer, the servicing company computer, or the additional computer.

Further, in at least some example embodiments, the present disclosure relates to a tractor operation or status monitoring and alert method for facilitating lease financing of tractors for tractor-trailers. The method includes providing at least one equipment leasing company computer including a front end server, a back end server, and a database, where the at least one equipment leasing company computer is configured to engage in communications with a plurality of other computers including each of a first financial institution computer, a dispatching company computer, a lessee computer, a servicing company computer, and an additional computer including at least one cloud server. Also, the method includes receiving first information at the at least one equipment leasing company computer regarding either an operation or a status of a first leased tractor at the database, where the first information is received from the at least one cloud server and is based at least indirectly upon second information obtained by a sensing device or engine control unit (ECU) supported on or associated with a first leased tractor. Further, the method includes performing first processing in regard to the first information to generate first processed information that includes a first report regarding the first leased tractor, and sending the first report for receipt by the financial institution computer.

Additionally, the method includes determining at the at least one equipment leasing company computer, at least in part based upon the first information or second information, whether the first leased tractor has failed to meet a first requirement of a first agreement pertaining to the lease financing of the first leased tractor, where the first requirement relates to whether a location of the first leased tractor is within or not within a prescribed region, whether a maintenance operation regarding the first leased tractor will soon be due or is past due, or whether a financial or insurance obligation related to the lease financing of the first leased tractor has been satisfied. Further, the method includes, if it is determined that the first leased tractor has failed to meet the first requirement, then sending at least one alert or notification for receipt by one or more of the first financial institution computer, a second financial institution computer, the dispatching company computer, the lessee computer, the servicing company computer, or the additional computer.

Notwithstanding the above examples, the present invention is intended to encompass a variety of other embodiments including for example other embodiments as are described in further detail below as well as other embodiments that are within the scope of the claims set forth herein.

### BRIEF DESCRIPTION OF THE DRAWINGS

Embodiments of the disclosure are disclosed with reference to the accompanying drawings and are for illustrative purposes only. The disclosure is not limited in its application to the details of assembly or arrangements of components, or orderings of process steps, illustrated in the drawings. The disclosure is capable of other embodiments or of being practiced or carried out in other various manners. In the drawings:

FIG. 1 is a block diagram schematically illustrating an example business relationship among entities or parties for achieving lease financing of tractors for tractor-trailers;

FIG. 2 is a schematic diagram illustrating an example tractor operation or status monitoring and alert system suited for facilitating lease financing of tractors for tractor-trailers;

FIG. 3 is a block diagram schematically illustrating example components of a computer which can be employed as any one (or more) of several computers included in the system of FIG. 2;

FIG. 4 is an additional schematic diagram illustrating an example tractor operation or status monitoring and alert system suited for facilitating lease financing of tractors for tractor-trailers; and

FIG. 5 is a flow chart illustrating an example tractor operation or status monitoring and alert method suited for facilitating lease financing of tractors for tractor-trailers, which for example can be performed by one or more of the systems described in FIGS. 2 and 4.

### DETAILED DESCRIPTION

The present inventors have recognized that there exists a need for an improved manner of conducting lease financing arrangements particularly in relation to tractors as employed in tractor-trailers (or semi-trailer trucks). In this regard, the present inventors have particularly recognized that the efficiency of implementing lease financing arrangements relating to tractors can be improved if enhanced systems and methods are employed so that information concerning the operations and/or statuses of leased tractors is obtained, collected, processed, output, and/or utilized in determining whether to take additional steps or actions.

Among other things, such information can be obtained from, and/or output or provided to, various entities or parties (e.g., companies or other institutions, or individuals) which are involved with such lease financing arrangements, such as the financial institutions from which the financing of leased tractors is provided, equipment leasing companies, dispatching companies (e.g., trucking companies or carriers), third party transportation companies, vehicle servicing companies, and/or the lessees (e.g., the truck drivers or operators of the leased tractors). Also, in at least some embodiments described herein, information is particularly obtained/collected by the computer(s) of an equipment leasing company. Based upon the information that is obtained/collected, tracking measures can be calculated regarding parameters such as (i) owner-operator lessee financial performance and efficiency, (ii) equipment usage and downtime that may impact a trucking company, and (iii) debt-service coverage, loan to value (LTV), and present value of future equity.

In at least some embodiments, systems and methods encompassed herein are advantageous in that the systems and methods enable the linking and assessing of owner-operator lessee performance information, and the financial returns to a financing company or equipment leasing company. In some embodiments, such information can facilitate the financing company's own Federal Reserve borrowing and/or fractionalization of commercial paper created by the lease financing activity. Also, the dispatching company (or trucking company or carrier) can benefit from the data that is obtained, collected, processed, and/or output, which informs about unseated time, repair and maintenance downtime, and recruiting turnover. Further, based upon the data that is obtained, collected, processed, and/or output, any of a variety of actions can be taken by the dispatching company and/or other entities (or individuals) such as, for example, the sending of alerts for servicing to be performed in regard to leased tractors, or alerts that leased tractors have moved outside of a geographic region within which the leased tractors are required to remain in accordance with their leases.

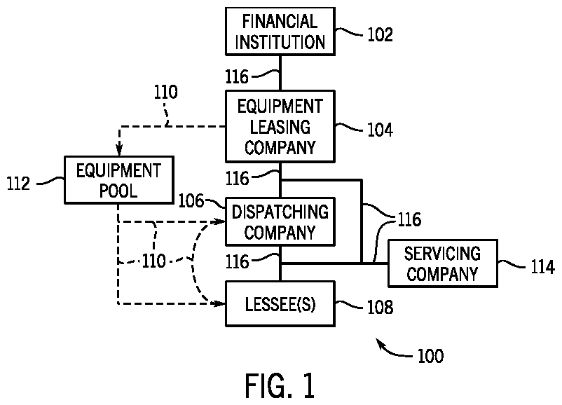

Referring to FIG. 1, a block diagram 100 illustrates schematically a business relationship among various entities or parties that are involved with a lease financing arrangement pertaining to the leasing of tractors employed in tractor-trailers. Depending upon the embodiment, the various entities or parties can be companies or other institutions, and/or individuals. In the present example embodiment, a lease financing arrangement is financed by way funds that are loaned from a financial institution 102 to an equipment leasing company 104. The funds loaned to the equipment leasing company 104 enable the equipment leasing company to purchase and own tractors of tractor-trailers. In turn, the equipment leasing company 104 is able to serve as a lessor of the tractors and lease the tractors to additional entities or parties.

In particular, the equipment leasing company 104 has a business relationship with a dispatching company 106 by which the tractors are leased from the equipment leasing company to the dispatching company. The agreement between the equipment leasing company and the dispatching company 106 in some cases includes not only a lease agreement but also a servicing agreement that sets forth requirements for servicing the leased tractors. The dispatching company 106 can in turn enter into one or more business relationships with one or more lessee(s) 108, which can be other companies or individual drivers/operators of the tractors. That is, the dispatching company 106 leases the tractors from the equipment leasing company 104, and the lessee(s) 108 in turn lease the tractors from the dispatching company 106. In alternate arrangements, it is also possible that leasing of the tractors is accomplished by leasing contracts directly between the lessee(s) 108 and the equipment leasing company 104 (without the dispatching company 106 as an intermediary).

Correspondingly, as illustrated by dashed arrows 110, one or more tractors encompassed by an equipment pool 112 can be leased from the equipment leasing company 104 to the lessee(s) 108 indirectly by way of the dispatching company 106 (or, in alternative arrangements, leased directly from the equipment leasing company to the lessee(s)). Further as shown, a servicing company 114 can also be involved with the overall business relationship as shown by the block diagram 100, insofar as the servicing company can perform service or maintenance in regard to the leased tractors and this information can be provided to the dispatching company 106 in accordance with a servicing agreement that is part of, or required as part of, the lease agreement. In some cases, servicing under the servicing agreement may include pool leasing by the equipment leasing company 104 to the dispatching company (or trucking company or carrier) 106 and/or to the independent contractors/operators/drivers who correspond to the lessees 108 shown in FIG. 1.

The block diagram 100 is intended to be representative of a variety of arrangements that can be established among various parties to achieve lease financing of tractors. The particular interrelationships, which are established by agreements among the various entities or parties to the business arrangement, are represented by links 116 in the block diagram 100 of FIG. 1. These agreements, and/or obligations taken on, by and among the various entities/parties illustrated in the block diagram 100, can vary depending upon the circumstance.

In at least some circumstances, the financial institution 102 and equipment leasing company 104 can have an agreement by which funds are loaned by the financial institution to the equipment leasing company, and interest and principal payments are paid back to the equipment leasing company to the financial institution. Also, the equipment leasing company 104 can have an agreement with each of the dispatching company 106 and the servicing company 114 (a “tri-party agreement) by which the tractors are leased to the dispatching company by the equipment leasing company and additional servicing obligations relating to the leased tractors are established. Further, the dispatching company 106 can have a further agreement with the lessee(s) 108 and possible again with the servicing company 114 according to which the tractors are leased (or sub-leased) by the dispatching company to the lessee(s) and the lessee(s) agree again to take on servicing obligations.

Notwithstanding the particular example entities and parties that are shown in FIG. 1, it should be appreciated that the numbers of the different types of entities/parties that are involved in establishing and conducting lease financing arrangements with respect to tractors can vary depending upon the circumstance. For example, although FIG. 1 envisions that there can be any one or more of the lessee(s) 108, and typically will be multiple lessees, that interact with a given dispatching company 106 and/or equipment leasing company 104 (and/or servicing company 114), there also can be more than one of any of the financial institution 102, equipment leasing company 104, dispatching company 106, and/or servicing company 114. For example, there will typically be multiple servicing companies as represented by the servicing company 114 that perform service/maintenance with respect to different ones of the leased tractors or even with respect to the same tractor at different times or when that tractor is at different locations.

The financial institution 102 is intended to be representative of any one or more financial institutions that provide capital to allow for the purchase and leasing of tractors, in a manner consistent with banking laws and regulations. The financial institution can be, for example, a national bank, which is permitted to engage in equipment leasing activities, including an operating subsidiary of a national bank (as leasing activities of a national bank through a subsidiary are governed and regulated as if the national bank itself is engaged in the leasing program). Also for example, the financial institution can be a FinTech Chartered financial institution (or special purpose national bank) that serves a role of making loans as authorized by the United States Office of the Comptroller of the Currency (OCC).

It should be appreciated that, by limiting leasing activity to tractors (or other types of commercial vehicles), various consumer concerns and regulations are inapplicable. For example, the rules pertaining to the lease financing of commercial vehicles by national banks do not require that a bank provide maintenance, insurance, parts, or accessories for the asset. These burdens instead can be shifted to the dispatching company (or trucking company or carrier) 106 and monitored by the equipment leasing company 104. The related expenses associated with the leasing of a given tractor can be passed to the lessee(s) 108, with the dispatching company (trucking company or carrier) 106 being secondarily responsible.

Still, if the financial institution is a national bank, various requirements will apply in the context of lease financing, for example, a requirement that the bank have proper internal controls. Further, if the financial institution 102 is a bank, it should be noted that, although banks cannot acquire property for lease in anticipation of a lease agreement (but rather can only acquire property for lease after the bank has entered into a legally binding written agreement that indemnifies the bank against loss in connection with its acquisition of the property or a legally binding written commitment to enter into a conforming lease), an appropriate agreement between the financial institution and the equipment leasing company 104 and/or dispatching company (trucking company or carrier) 106 will satisfy this requirement. Also, although a bank will be required to either liquidate off-lease property or re-lease it as soon as practical, and in all events within five (5) years, an appropriate equity transfer can satisfy this requirement. Further, although leases by national banks are subject to lending limit these requirements, such lending limit requirements can be met with appropriate leasing agreements or, in some cases, aggregating the leases per trucking company given the source of repayment.

The dispatching company 106 particularly can take on several responsibilities depending upon the embodiment or circumstance. For example, in one implementation, the dispatching company 106 can enter into a pooling, trust, and service (PTS) agreement with the equipment leasing company 104 (and/or possibly also with the financial institution 102) that establishes various responsibilities of the dispatching company. Such responsibilities can include, for example: (1) preparation, inspection and identification of equipment for deployment in full compliance with all laws and regulations; (2) providing, dispatching, and managing qualified drivers (e.g., the lessee(s) 108) who enter into a lease transaction; and (3) ensuring use and operation of the leased tractors in conformity with all laws and regulations, including maintaining a safety department for training and monitoring, and having in place appropriate safety policies and procedures.

Additionally, such responsibilities in accordance with a PTS agreement can also include: (4) collecting funds and administering driver settlements, including ensuring payment and enforceability of all required insurance, providing for all required maintenance and repairs, and paying over to the equipment leasing company 104 all required rent and other lease obligations; (5) to the extent of driver turnover and attrition, recovering and redeploying the leased equipment (tractors); (6) paying the per-truck monthly lease payment to the equipment leasing company 104; (7) providing accounting and financial information as requested by equipment leasing company 104; (8) sending lease applications to qualified drivers (e.g., the lessee(s) 108) during orientation; (9) providing deployment pictures to the equipment leasing company 104 at the times of lease for each qualified lessee; and (10) acting in accordance with limits on deductions and surcharges.

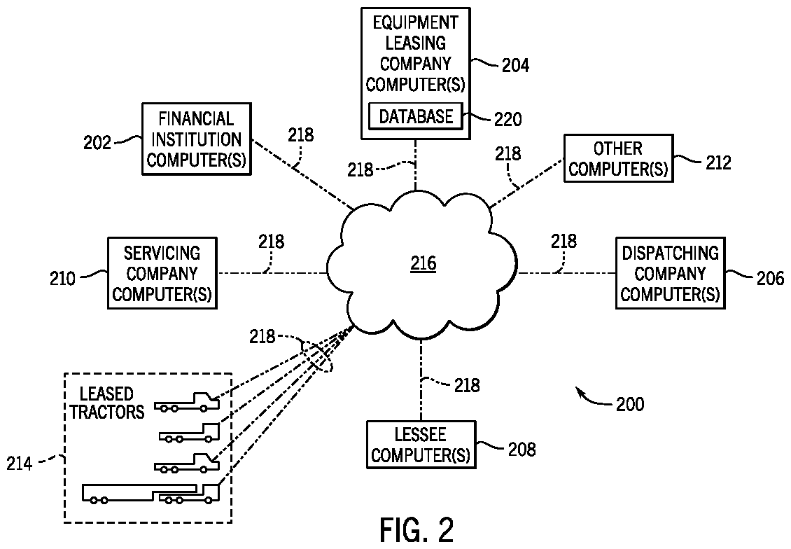

Turning to FIG. 2, an example tractor operation or status monitoring and alert system 200, which serves to facilitate lease financing of tractors for tractor-trailers, is shown in schematic form. As illustrated, the system 200 includes each of one or more financial institution computer(s) 202, one or more equipment leasing company computer(s) 204, one or more dispatching company (or trucking company or carrier) computer(s) 206, one or more lessee computer(s) 208, one or more servicing company computer(s) 210, one or more other computer(s) 212, and one or more leased tractors 214—where, in this example, multiple leased tractors are shown within a dashed box. Although the system 200 is shown in FIG. 2 to include each of the computers 202, 204, 206, 208, 210, and 212, in addition to the leased tractors 214, depending upon the embodiment one or more of these types of computers need not be present. For example, in some embodiments, none of the other computer(s) 212 are present and, in some other embodiments, lessee(s) do not interact with the system 200 by way of any lessee computers corresponding to the lessee computer(s) 208. The equipment company computer(s) 204 particular are shown to include (or operate in association with) a database 220.

Further as shown, the system 200 is one in which the computer(s) 202, 204, 206, 208, 210, and 212 and leased tractors 214 can engage in communications with one another by way of the internet or World Wide Web (WWW) 216. The computers 202, 204, 206, 208, 210, and 212 and leased tractors 214 can be connected to the internet (or WWW) 216 by way of one or more additional communication links 218. The additional communication links 218 can be, but need not be, considered part of the internet (or WWW) 216. Notwithstanding the manner in which the additional communication links 218 are shown in FIG. 2, it should be appreciated that the additional communication links 218 are representative of any arbitrary number of additional communication links that can be present depending upon the embodiment. For example, although a single one of the additional communication links 218 is shown to be coupled directly to the lessee computer(s) 208, depending upon the embodiment (e.g., depending upon the number of the lessee computer(s) that are present), the number of additional communication links 218 can also vary.

In other embodiments encompassed herein, one or more of the computer(s) 202, 204, 206, 208, 210, 212, and leased tractors 214 can be in communication with one another by way of communication links that do not involve the internet (or WWW) 216, such as intranet links, Ethernet links, or other communication links. For example, during servicing of one of the leased tractors 214 involving one of the servicing computer(s) 210 (e.g., of the servicing company 114), the leased tractor can potentially be in communication with the servicing computer by way of an Ethernet link.

Indeed, the present disclosure generally envisions and encompasses any of a variety of embodiments in which any of the leased tractors 214 and/or computers 202, 204, 206, 208, 210, and 212 engage in communications with one another by way of any of a variety of communication links or media, including communication links or media that involve the internet (or WWW) as well as communication links or media other than, or in addition to, internet-based communication links or media. Further for example, the communication links or media that can be employed in various embodiments can include any of a variety of wired or wireless communication links or media involving electrical cables such as coaxial cables, fiber optics or other optical communications media or technologies, digital subscriber lines (DSLs), cellular technologies (e.g., 3G, 4G, or 5G), Wi-Fi communications, Bluetooth communications, radio wave, microwave, infrared, or other wired or wireless communications technologies.

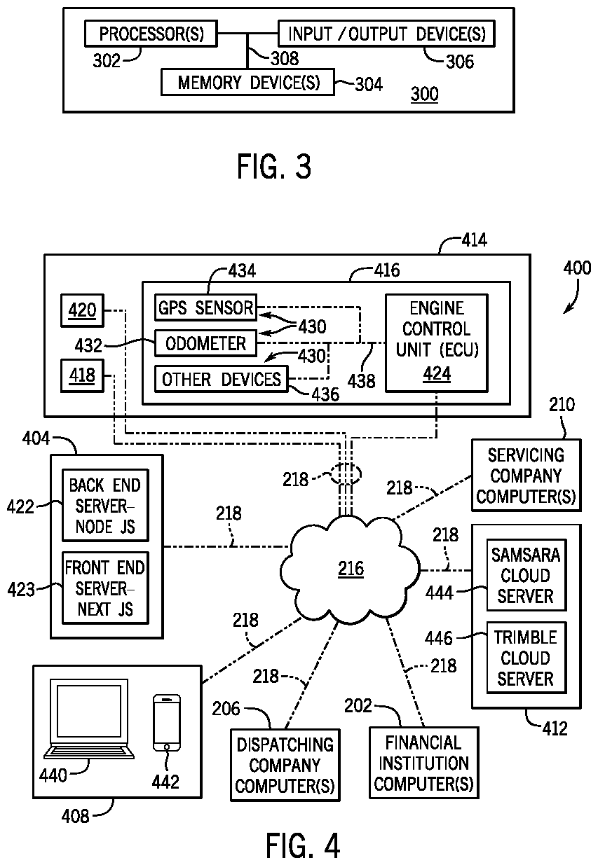

Referring additionally to FIG. 3, in at least some embodiments encompassed herein, each of the financial institution computer(s) 202, equipment leasing company computer(s) 204, dispatching company computer(s) 206, lessee computer(s) 208, servicing computer(s) 210, and other computer(s) 212, as well as one or more computer(s) (or computerized devices) provided within the leased tractors 214, takes the form of a computer 300. As shown schematically in FIG. 3, the computer 300 includes one or more processor(s) (or processing device(s)) 302, one or more memory (or storage) device(s) 304, and one or more input and/or output (I/O) device(s) 306. Additionally as shown, the processor(s) 302, memory device(s) 304, and I/O device(s) 306 are in communication with one another, directly or indirectly, by way of one or more internal communication link(s) 308.

Further referring to FIG. 3, each of the one or more processor(s) 302 (simply referred to as the processor(s) 302 below) can take any of a variety of forms depending upon the embodiment, and can include any of a variety of one or more systems, devices, or components that perform any of a variety of types of processing or calculation operations. For example, depending upon the embodiment, the processor(s) 302 can respectively be implemented by way of respective hardware devices or components, firmware, or software implemented upon hardware encompassed by the processors. Also for example, the processor(s) 302 can be or include one or more microprocessors, one or more microcomputers, or one or more other forms of processing devices such as programmable logic devices (PLDs) or application specific integrated circuits (ASICs). The processor(s) 302 can be operated in accordance with various computer-executable instructions so as to perform any of a variety of different functions related to the performing of processing and taking of other actions as described herein.

The one or more memory device(s) 304 (simply referred to as the memory device(s) 304 below) can store any of a variety of types of information or data depending upon the embodiment or implementation. Among other things, the memory device(s) 304 can store software, applications, or computer instructions in accordance with which one or more of the processor(s) 302 operate. Also, as described further herein, the memory device(s) 304 can store any of a variety of information/data concerning the statuses or operations of the leased tractors 214, financial information/data regarding the leasing of the leased tractors, and/or other types of information/data such as (for example) information/data regarding the location(s) at which or environment(s) within which the leased tractors are positioned or being operated. Further, the memory device(s) 304 can store information/data that is based upon or derived from, by processing, any of such types of status, operational, financial information/data, and/or other information/data. The database 220 included within the equipment leasing company computer(s) 204 particularly is one (or includes several) of the memory device(s) associated with those equipment leasing company computer(s).

The memory device(s) 304 can take any of a variety of forms or encompass any of a variety of different types of systems, devices, or components depending upon the embodiment. For example, in some embodiments, any one or more of the memory device(s) 304 can employ any of magnetic disk storage, optical disk storage, random access memory (RAM) devices, read only memory (ROM) devices, compact disc read only memory (CD/ROM) devices, electrically erasable programmable read only memory (EEPROM) devices, or other forms of storage devices or computer-readable storage media. In some embodiments, the processing and memory functionality associated with the processor(s) 302 and memory device(s) 304 of any one of the computer(s) 202, 204, 206, 208, 210, and 212, or any computer(s) within the leased tractors 214, can take the form of a single device that has both processing and memory capabilities (e.g., a processor-in-memory or PIM).

In at least some embodiments, one or both of the processing or memory functionality provided by the processor(s) 302 and/or memory device(s) 304 of any of the computer(s) 202, 204, 206, 208, 210, and 212, or any computer within any of the leased tractors 214, can be provided by way of multiple processing and/or memory systems, devices, or components that are located in a variety of physical locations or distributed among a variety of systems, or subsystems. Among other things, in at least some embodiments encompassed herein, one or more of the processor(s) and/or memory device(s) of any of the computer(s) 202, 204, 206, 208, 210, and 212, or any computer within any of the leased tractors 214, can be provided in or by a cloud computing system (e.g., implemented in the cloud) formed from or encompassing numerous processors and memory devices respectively located apart from one another (or distributed) at many separate and distinct locations. Further for example, in at least some embodiments, the database 220 (or portions of the database) of any of the equipment leasing company computer(s) 204 can be implemented in or by a cloud computing system.

As for the I/O device(s) 306, these can include any of a variety of systems, devices, or components that permit signals or information to be input to (received by) the computer 300 from, or output from the computer 300 for receipt by, one or more other computers, systems, devices, or components, or individuals (e.g., people interfacing with the computer 300). The I/O device(s) 306 thus permit the computer 300 to intercommunicate or interact with other computers, systems, devices, or components, or individuals. More particularly, the I/O device(s) 306 can for example include ports or terminals, wireless transceivers or Wi-Fi hotspots that facilitate wireless communications, and/or devices such as video displays or monitors, touch screens, keyboards, mouse devices, joysticks, and speakers. The I/O device(s) 306 can be located at the same or substantially the same locations as the processor(s) 302 and/or memory device(s) 304 of the computer 300, but also can be located remotely from the processor(s) 302 and/or memory device(s) 304 of the computer.

Further, it should be recognized that the computer 300 of FIG. 3 is representative of a variety of different types of computers (or computer devices or computer systems) that can be implemented depending upon the circumstance or embodiment. Such different types of computers represented by the computer 300 can include, for example, personal computers such as laptop, notebook, or desktop computers, or mobile devices such as smart phones, cellular telephones, hand held devices or handsets, smart wristwatches, or other mobile computing devices, mainframe computers, or computers associated with cloud computing systems. It should also be recognized that different ones of the financial institution computer(s) 202, equipment leasing company computer(s) 204, dispatching company computer(s) 206, lessee computer(s) 208, servicing computer(s) 210, and other computer(s) 212, as well as the computer(s) (or computerized devices) provided within the leased tractors 214, can respectively be of these different types. For example, in one embodiment, the dispatching company computer(s) 206 can be desktop or laptop computers, or mainframe computers, but the lessee computer(s) 208 can be mobile devices.

Also in some embodiments, different ones of the financial institution computer(s) 202, equipment leasing company computer(s) 204, dispatching company computer(s) 206, lessee computer(s) 208, servicing computer(s) 210, and other computer(s) 212, as well as the computer(s) (or computerized devices) provided within the leased tractors 214, can intercommunicate/interact with one another in any of a variety of matters. In some embodiments, for example, one or more of these computers can interact with one or more others of these computers in accordance with a client-server model or architecture. Further for example, in some such embodiments one or more of the equipment leasing company computers 204 can be a server computer and one or more the dispatching company computer(s) 206, lessee computer(s) 208, servicing computer(s) 210, and/or financial institution computer(s) 202 can be client computer(s). Additionally for example, in some embodiments, multiple ones of the computers can interact with one another in a peer-to-peer manner.

As will be described in further detail herein, information/data in large quantities and of many different types can be obtained, collected, and/or tracked from a variety of sources within the system 200, including the leased tractors 214 and/or one or more of the computers 202, 204, 206, 208, 210, and 212 (and/or potentially from sources outside of the system). Indeed, it is envisioned that, depending upon the embodiment, information/data can be taken and utilized from any sensor, data aggregator, or other source. Additionally, information/data that is obtained or collected can also be stored within the memory device(s) 304 of one or more of the computers 202, 204, 206, 208, 210, and 212, and/or any of the computer(s) of the leased tractors 214, and/or processed by the processor(s) 302 of one or more of those computers. Further, information/data that is obtained or collected (or stored or processed) can also be communicated among two or more of the computers 202, 204, 206, 208, 210, and 212, and/or any of the computer(s) of the leased tractors 214, and/or communicated between those computers and other entities or parties (including persons/human operators), by way of the I/O device(s) 306 of those computers as well as the internet (or WWW) 216 and/or one or more of the additional communication link(s) 218.

Turning to FIG. 4, in at least some embodiments, the system 200 more particularly takes the form of a system 400. As with the system 200, the system 400 again includes the financial institution computer(s) 202, dispatching company (or trucking company or carrier) computer(s) 206, and servicing computer(s) 210, which are coupled to and in communication with one another by way of the internet (or WWW) 216 and additionally by way of corresponding ones of the additional communication links 218. However, in place of the equipment leasing company computer(s) 204, the system 400 includes equipment leasing company computer(s) 404 that, in the present embodiment, include each of a back end server 422 and a front end server 423. In the present example embodiment, the back end server 422 particularly is a Node JS server utilizing the Node JS server environment available from the OpenJS Foundation of San Francisco, California, and the front end server 423 particularly is a Next JS server utilizing the Next JS framework maintained by Vercel of San Francisco, California, although in other embodiments these servers can take other forms.

In the present embodiment, the computer program(s) operating on the system 400 can be programmed in Typescript (or JavaScript). Nevertheless, it should be appreciated that the present disclosure is not limited to systems having computers that operate in accordance with computer programs that are programmed in JavaScript, Typescript or any other particular computer programming language(s), but rather the present disclosure encompasses any of a variety of embodiments employing any of a variety of computer programs or code programmed by way of any one or more of a variety of different programming language(s) and/or that, in at least some embodiments, employ or implement any one or more of a variety of algorithms or processing or calculation rules, methods or techniques. Also, in at least some embodiments, the database 220 of FIG. 2 can be viewed as part of, or corresponding to, one or both of the back end server 422 and the front end server 423. In other embodiments, the database 220 of FIG. 2 can be distinct from the back end server 422 and from the front end server 423.

Also, in contrast to FIG. 2, FIG. 4 not only shows schematically a plurality of leased tractors 414 including (in this example) first, second, and third leased tractors 416, 418, and 420, respectively, but also shows schematically several example internal components of the first leased tractor 416. More particularly as shown, the first leased tractor 416 includes an engine control unit (ECU) or module 424, which is a type of computer (alternatively, the first tractor 416 can employ an electronic control unit or module in place of, or in addition to, an engine control unit). Additionally, the first tractor 416 also includes a plurality of additional devices 430, which are shown to include an odometer 432, a global positioning system (GPS) sensor 434, and other devices 436. The GPS sensor 434 in some embodiments can be a Verizon Connect GPS fleet tracking device (or Verizon tracker) available from Verizon Communications Inc. of New York, New York. (In some embodiments, such a Verizon tracker when implemented on a leased tractor is capable of receiving and responding to a ping signal from another device such that, if there is a desire at the equipment leasing company to locate the leased tractor, a signal sent by the equipment leasing company computer will result in a response signal being provided by the Verizon tracker indicating the location of the leased tractor within a small range such as within three meters).

The other devices 436 can include, for example, any of a variety of sensors within the first tractor 416 that detect or measure various operational characteristics of the first tractor 416 such as, further for example, engine temperature, engine rotations per minute (RPM), tire pressure, oil pressure, and battery charge. In some additional embodiments, one or more of the GPS sensor 434 (and/or odometer 432) and/or other devices 436 can be provided as part of an internet-of-things (IoT) system implemented on the first leased tractor 416 (or other leased tractor), which collects and makes available information/data regarding that leased tractor, as can be provided by Spireon, Inc., of Irvine, California (formerly LoJack Corp.).

In the present embodiment, all of the additional devices 430 are shown to be coupled (directly or at least indirectly) with the ECU 424 by way of an internal bus 438 (represented by a dashed line). The internal bus 438 is representative of any of a variety of one or more communication link(s), which can be wired and/or wireless communication link(s), and which allow for internal communications of the ECU 424 with each of the additional devices 430. In some embodiments, the internal bus 438 can be or include a controller area network (CAN) bus. Further, as illustrated, it should be appreciated that the ECU 424 particularly is in communication with the internet (or WWW) 216 by way of a respective one of the additional communication links 218 (e.g., by way of a corresponding one of the I/O devices 306 of the ECU). Accordingly, the ECU 424 is able to communicate with one or more other computer(s) that are coupled to the internet (or WWW) 216 and also able to send, for receipt by any of those other computer(s), information/data received by the ECU from any of the additional devices 430. Such computer(s) with which the ECU 424 can communicate can include any one or more of the computer(s) 202, 404 (or 204), 206, 408 (or 208), 210, and 412 (or 212). In the present embodiment, it is particularly envisioned that the ECU 424 will communicate with the computers 412.

It should be appreciated that, although FIG. 4 only shows example internal components of the first tractor 416, each of the second and third leased tractors 418 and 420 also include respective internal components that can be, but need not be, the same as the internal components of the first tractor 416. Also, although only a single ECU is shown to be provided in the first tractor 416, it should be appreciated that in other embodiments multiple ECUs and/or other computers (including for example an electronic control unit or module) can be included in the first tractor (or the second or third tractors). Also, in other embodiments, the additional devices 430 can include any arbitrary number of devices of any of a variety of types, including one or more sensing devices as well as one or more actuators or control devices. Further, although FIG. 4 shows that the additional devices 430 are coupled to the internet (or WWW) 216 indirectly by way of the ECU 424 and the internal bus 438 in addition to one of the additional communication links 218, in other embodiments one or more of the additional devices 430 can be directly coupled to the internet or coupled in a manner that does not require communication to occur via the ECU 424.

Further in contrast to FIG. 2, FIG. 4 shows lessee computer(s) 408 as including each of a laptop computer 440 and a mobile device 442. The laptop computer 440 and mobile device 442 are provided to illustrate examples of types of computers that a given lessee (or multiple lessees) can utilize to interact with other portions of the system 400, including one or more of the other computer(s) of the system 400 such as the front end server 423 of the equipment leasing company computers 404.

Additionally, FIG. 4 also shows the system 400 as including other computers 412 that particularly include a first cloud server 444 and a second cloud server 446. In the present embodiment, the first cloud server 444 can be a Samsara cloud server as provided by Samsara Inc. of San Francisco, California, and the second cloud server 446 can be a Trimble cloud server as provided by Trimble Inc. of Westminster, Colorado.

Further in this regard, the first (Samsara) cloud server 444 serves as an electronic logging device (ELD) regarding operation of the leased tractors 414. To serve as the ELD, the first (Samsara) cloud server 444 engages in communications, via the internet 216 (and appropriate ones of the additional communication links 218), with the leased tractors 414 so as to particularly obtain and store information regarding the locations of the leased tractors. Such information can be provided from GPS sensors of the leased tractors 414, such as the GPS sensor 434, and in at least some embodiments is provided in real time (or effectively real time, or with a high frequency, such as every minute or every five minutes). In some embodiments, when serving as the ELD, the first (Samsara) cloud serve 444 also obtains and stores other types of information such as, for example, information regarding miles driven, engine hours (hours the engines of the leased tractors are operating), and engine power status.

Additionally, the second (Trimble) cloud server 446 allows for implementation of software such as TMT Fleet Maintenance software and/or TMW.Suite transportation management software (also available from Trimble Inc.). By virtue of this software, the second (Trimble) cloud server 446 obtains and accumulates information/data regarding maintenance of the leased tractors 414 as well as provides warranty tracking functionality. The second (Trimble) cloud server 446 again receives information from the servicing company computer(s) 210 regarding the servicing or maintenance, or operability or health status, of the leased tractors 414. Such information/data can be automatically received by the servicing company computer(s) 210, or manually entered (e.g., by technicians) for receipt by the servicing company computer(s), when maintenance has been performed and/or is completed. Thus, information/data regarding maintenance and servicing of a given one of the leased tractors 414 can be provided/uploaded to the second (Trimble) cloud server 446 by the servicing company providing the maintenance/servicing, by way of one or more of the servicing company computer(s) 210 associated with that servicing company, when maintenance has been performed and/or is completed.

In alternate embodiments, the second cloud server 446 can also obtain information in other manners. For example, in some alternate embodiments, the second cloud server 446 can also obtain information from the leased tractors 414, as can be provided by the ECUs of the leased tractors such as the ECU 424 of the first tractor 416 via the internet 216 (and appropriate ones of the additional communication links 218). Such information received from the leased tractors 414 (e.g., from an ECU such as the ECU 424) by the second cloud server 446 can include, for example, odometer information from odometers such as the odometer 432. Such information for example can be received in real-time or on a periodic or other basis.

Further with respect to FIG. 4, in accordance with at least some embodiments, one or more of the equipment leasing company computer(s) 404 particularly operate to obtain and collect information/data regarding the leased tractors 414 and the operation thereof, by communicating with the first (Samsara) cloud server 444 and the second (Trimble) cloud server 446. In at least some cases, the communication of information/data from the first (Samsara) cloud server 444 and/or the second (Trimble) cloud server 446 to the equipment leasing company computer(s) 404 can be automatically performed, and/or performed in real time.

For example, location information regarding the leased tractors (leased equipment) 414 can be populated using an application programming interface (API) between software (e.g., software running on the equipment leasing company computer(s) 404) and the first (Samsara) cloud server 444. In some embodiments, the equipment leasing company computer(s) 404 (e.g., the database 220) can be populated with a variety of historical and current values of various types of information/data. Although the present description envisions the implementation of systems such as the first (Samsara) cloud service 444 and the second (Trimble) cloud server 446, the present disclosure also includes embodiments employing any of a variety of different types of cloud servers, other computer devices and sensors, and other systems and components that allow for the sensing and accumulation/collection of information/data regarding the operation/status of the leased tractors 414 including their locations. Among other things, the present disclosure also encompasses other embodiments employing any independently verifiable location tracking system for determining the locations(s) of one or more of the leased tractors 414.

Further for example, in some embodiments, accounting and payment systems are implemented on the equipment leasing company computer(s) 404. In some such embodiments, such accounting and payment systems can include or be populated with information/data using Microsoft Great Plains (or Microsoft Dynamics Great Plains) software, which is available from Microsoft Corp. of Redmond, Washington, and which is supported by Trimble Inc. Also, in some example embodiments, there can be transferring of the source from JavaScript to Typescript. Nevertheless, it should be appreciated that the present disclosure is not limited to JavaScript, Typescript or any other computer programming language, but rather the present disclosure encompasses any of a variety of embodiments employing any of a variety of computer programs or code programmed by way of any one or more of a variety of different programming language(s) and/or that, in at least some embodiments, employ or implement any one or more of a variety of algorithms or processing or calculation rules, methods or techniques. Further, although in some embodiments or implementations information/data can be presented or stored in the form of spreadsheets or PDF (Portable Document Format) documents, the present disclosure in other embodiments or implementations can also (or instead) operate to present or store information/data in any of a variety of other formats, or by way of any of a variety of other applications or programs.

Based upon the received information/data, the equipment leasing company computer(s) 404 then processes that information/data to generate processed information/data, such as reports, that can be provided to the financial institution computer(s) 202. The software operating on the equipment leasing company computer(s) 404 can for example put received information/data into the database 220 and generate processed information/data (e.g., reports) that is sent to the financial institution computer(s) 202 on a monthly, weekly, daily, or other (e.g., more frequent) basis. Such information/data and/or reports that can be generated and provided by the dispatching company computer(s) can include, for example, debt-service coverage ratio (DSCR) reports, loan to value (LTV) ratio reports, and/or final accounting collection value reports regarding leased tractor(s) 414, as well as driver list value(s). The information/data and/or reports can be provided in any of a variety of formats, including as a spreadsheet or as a PDF.

The processing by the equipment leasing company computer(s) 404 can take any of a variety of forms and proceed in any of a variety of manners depending upon the embodiment or circumstance. In some embodiments or circumstances, processing is performed by way of software that is configured to perform rigid calculations. Also, in some embodiments or circumstances, the software is configured to operate in a manner by which it is possible to determine which values or data are incorrect, and/or which calculations were performed on it. Further, in some embodiments or circumstances, various processing or calculations are performed automatically, such as calculations regarding DSCRs and LTV ratios. Also, automatic payments can be automatically entered and used in any loan calculations. At the same time, in some embodiments or implementations, portions of the processing or calculations can be performed manually or partly manually. For example, in some embodiments, there can be a manual override for certain types of data entry (e.g., regarding automatic entry of payments), even though other calculations (again for example regarding DSCRs, LTV ratios) are automatic.

Although the processing of information/data and/or report generation by the equipment leasing company computer(s) 404 can be automatically performed, there can still be available a manual override option. Also, all changes can be tracked, and potential subsequent errors are indicated in the system (which can trace the calculations that relied on erroneous data). Further, historical data can be preserved in a separate table even after manual changes. Items can be separated to avoid processor speed degradation.

Based upon the processed information/data or reports from the equipment leasing company computer(s) 404, the equipment leasing companies associated with the equipment leasing company computer(s), and/or the financial institutions associated with the financial institution computer(s) 202, can assess the status of lease financing arrangements that pertain to the different leased vehicle(s). In at least some circumstances, based upon these assessments, the equipment leasing companies or financial institutions can take further actions, including further actions by the equipment leasing company computer(s) 404 and/or financial institution computer(s) 202. Also, in at least some circumstances, the dispatching company computer(s) 206 can take further actions based upon the processed information or results, or assessments based thereon, or in response to signals, instructions, or commands received from the equipment leasing companies (or the equipment leasing company computer(s) 404) or the financial institutions (or the financial institution computer(s) 202).

For example, in some lease financing arrangements, maintenance schedules can be defined in the lease agreements. In some embodiments, therefore, if based upon an assessment of processed information or reports it is determined that one or more maintenance obligations required by a lease financing arrangement involving one of the leased tractors 414 are not being met, then one of the financial institution computer(s) 202, equipment leasing company computer(s) 404, or dispatching company computer(s) 206 can send one or more alerts to avoid or rectify non-compliance.

Also for example, odometer readings can be used to determine maintenance requirements. In such a scenario, the equipment leasing company computer(s) 404 can compare odometer information concerning one or more of the leased tractor(s) 414 and compare that information to thresholds setting forth when maintenance is due based on the odometer reading. If the odometer information indicates that a given threshold has been passed such that maintenance is due but has not yet been performed with respect to a given one of the leased tractor(s) 414 in accordance with the lease pertaining to that tractor, then the equipment leasing company computer(s) 404 can send an alert to provide notice that maintenance is due and has not yet been done. Such an alert, for example, can be provided to an appropriate one of the lessee computer(s) 408 associated with the lessee of that leased tractor for which maintenance is overdue. Additionally, such an alert can be sent in any of a variety of manners, including for example by sending a message or ping to a Verizon tracker (that is, the Verizon Connect GPS fleet tracking device mentioned above) associated with the leased tractor for which maintenance is due.

Further, if it is determined that maintenance is long overdue with respect to certain one(s) of the leased tractor(s) 414, one or more further alerts can be provided from the equipment leasing company computer(s) 404 to the dispatching company computer(s) 206. The dispatching company computer(s) 206 in turn can send notifications to one or more of the lessee computer(s) 408 of the lessee(s) who are associated with the leased tractor(s) 414 for which maintenance is overdue, directing the lessee(s) to promptly take action to address the maintenance issues. Additionally in such circumstance when maintenance is long overdue, the dispatching company computer(s) 206 can also send notifications to one or more of the servicing company computer(s) 210 to notify the employees at the associated servicing company or companies that maintenance is urgently needed. Also, in some implementations, signals can be sent to the leased tractor 414 for which maintenance is overdue, so as to automatically cause a maintenance due warning light to be illuminated on the dashboard of the tractor.

The equipment leasing company computer(s) 404, financial institution computer(s) 202, and/or dispatching company computer(s) 206 can also send alerts in other circumstances as well, based upon the processed information/data or reports generated by the equipment leasing company computer(s). For example, alerts can be sent by any of those computers if a given one of the leased tractors 414 is missing or appears to not be reachable. Also, alerts can be sent if any listed equipment is moved into an area from which it was excluded or leaves an area to which the equipment was restricted (geo-fenced, e.g., to prevent from travelling out of state or into particular countries). Further, alerts can be sent if one or more portions of data regarding a given one of the leased tractors 414 is missing or not available. Also for example, alerts can be sent by any of those computers regarding a given one of the leased tractors 414, if the LTV ratio (or a DSCR) concerning that leased tractor is off (or at an undesirable level), or if one or more lease payments concerning that leased tractor have been missed, or if insurance pertaining to that leased tractor has lapsed or is about to expire.

It should be appreciated that the present disclosure encompasses a wide variety of methods, processes, and manners of operation of the system 400 and the components thereof, including manners of operation that for example involve any one or more of: (a) one or more different manners of intercommunication among the computers 202, 404 (or 204), 206, 408 (or 208), 210, 412 (or 212), and the leased tractor(s) 414 (or 214) and internal components thereof; (b) one or more of accumulating, obtaining (or sensing), and processing of information/data; and (c) taking any of a variety of actions in response to or based upon such intercommunications and/or information/data.

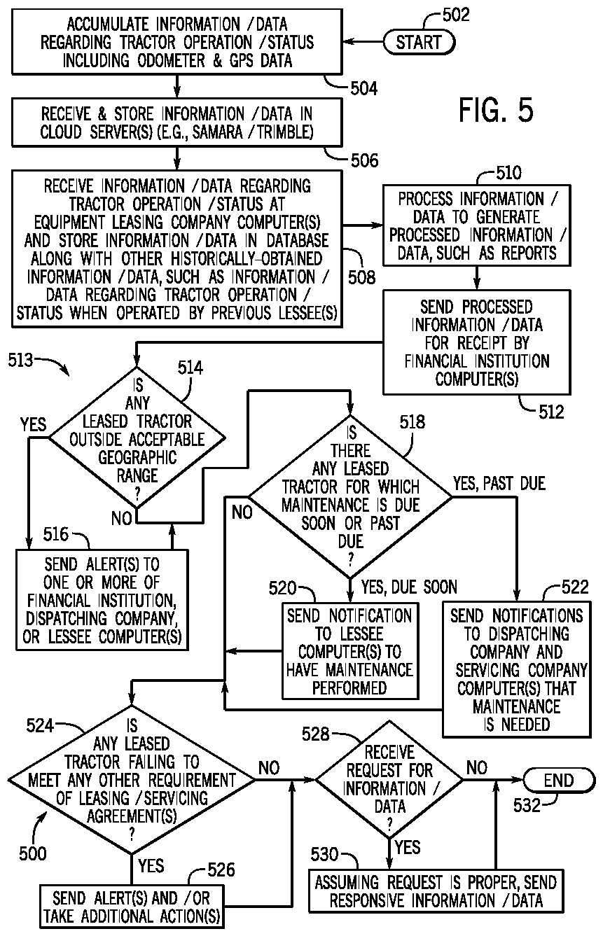

Turning to FIG. 5, a flow chart 500 is provided to show one example method of operation of the system 400 (which can be considered a tractor operation or status monitoring and alert method for facilitating lease financing of tractors for tractor-trailers). As illustrated, upon beginning at a start step 502, the method begins at a step 504 in which information/data regarding the operation(s) and/or status(es) of one or more of the leased tractor(s) 414 is accumulated or obtained. Such information/data that is accumulated or obtained can include odometer data and/or GPS data, and can also include any of a variety of other types of data as well, such as are mentioned above (e.g., engine temperature). In the present example, the step 504 can be understood to refer to the accumulation of information/data at the leased tractor(s) 414, for example, within the internal components thereof such as the ECU 424 of the first leased tractor 416.

Next at a step 506, information/data is communicated from the leased tractor(s) 414 for receipt by one or more cloud server(s), at which that information/data is received and stored. The information/data that is communicated to, and received and stored at, the cloud server(s) can include any of the types of information/data that is accumulated or obtained at the leased tractor(s) 414, and in the present example again can include information/data regarding the operation(s) and/or status(es) of one or more leased tractor(s) 414. The cloud server(s) at which the information/data is received and stored can include any of the first cloud server 444 and the second cloud server 446, which respectively for example can be a Samsara cloud server and a Trimble cloud server as described above. In other embodiments, the information/data can be stored at other cloud server(s) and/or other ones of the other computer(s) 412.

Further, at a step 508, information/data is additionally communicated for receipt by one or more of the equipment leasing company computer(s) 404, at which that information is received and stored. In the present embodiment, such information/data particularly is communicated for receipt by the equipment leasing company computer(s) 404 from one or both of the first cloud server 444 and second cloud server 446 (or other ones of the other computer(s) 412). Such information/data may be communicated to the equipment leasing company computer(s) 404 in response to requests or commands sent by the equipment leasing company computer(s) to the first cloud server 444 and/or second cloud server 446, with the equipment leasing company computer(s) in such circumstances operating as clients of the first and/or second cloud servers. Upon arriving at the equipment leasing company computer(s) 404, the information/data in the present example embodiment may be stored in a database (or multiple databases) such as the database 220, which for example can be a part of a back end server such as the back end server 422 (or also for example can be independent of any back end server).

The information/data that is received and stored during the step 508 can supplement other information/data that has been previously or historically received and/or stored in the equipment leasing company computer(s) 404 or databases (or servers such as the back end servers) thereof. Such other, previously-received/stored information/data can include any of a variety of types of additional information/data including, for example, additional information/data regarding the operation(s) or status(es) of the leased tractor(s) 414. Also, such other information/data can include information identifying the various leased tractor(s) 414 or that is useful for the tracing of leased tractor(s) such as unit number, the VIN (vehicle identification number) number, and possibly a number assigned by a third party (e.g., a Samsara number), which information can be provided or entered when each leased tractor is deployed by a carrier. Further for example, in some circumstances, such additional information/data regarding the operations or status of any of the leased tractor(s) 414 can include information/data regarding the operations or status of the leased tractor(s) when those leased tractor(s) have been operated by previous lessee(s) other than the lessee(s) who are currently leasing those tractors.

Next, at a step 510, the equipment leasing company computer(s) 404 process one or more portion(s) of the information/data stored therein to generate processed information/data. Such processed information/data can take a variety of forms and, among other things, can include reports such as financial reports that are of interest to the financial institution(s) 102. Further, at a step 512, such processed information/data is sent by the equipment leasing company computer(s) 404 for receipt by the financial institution computer(s) 202 associated with (e.g., owned or operated by or at the direction of) the financial institution(s) 102.

Additionally as shown in FIG. 5, in the present example, after the step 512, a series of steps 513 is performed at which one or more portion(s) of information/data are analyzed so as to arrive at any of a variety of determinations, and at which one or more actions are taken (or not taken) based upon such determinations. Although the series of steps 513 is intended to illustrate example analyses/determinations and example actions that can be taken, the present disclosure also encompasses numerous other analyses/determinations and/or actions that can be taken (or not taken). Also, although in the present embodiment such analyses/determinations can be performed based upon (and such actions can be taken in response to such analyses/determinations based upon) the processed information/data generated at the step 510, in other embodiments such analyses/determinations are performed based upon any one or more portions of information/data that are available (e.g., the information/data received at the step 508, or other processed information/data).

Further, in the present embodiment, all of the analyses/determinations, and all of the actions that are taken, in the series of steps 513 are performed particularly by one or more of the equipment leasing company computer(s) 404. Nevertheless, in other embodiments, one or more of the analyses/determinations, and one or more of the actions that are taken, can be performed by any one or more other ones of the computer(s) 202, 206, 408 (or 208), 210, 412 (or 212), or even by one or more of the leased tractor(s) 414 (or 214) or component(s) thereof, alone or in combination with one or more of the equipment leasing company computer(s) 404.

In the present example, the series of steps 513 begins with a step 514 (which immediately follows the step 512), at which a determination is made by the equipment leasing company computer(s) 404 as to whether any of the leased tractor(s) 414 is outside of an acceptable geographic range (or outside of its geographic fence or geofence). For example, an equipment lease may require that a given one of the leased tractor(s) 414 remain within a particular state of the United States. If it is determined, based (at least indirectly) upon the GPS data obtained from that leased tractor, that the leased tractor has exited a that state, then in such circumstance a determination will have been made that the leased tractor is outside of its acceptable geographic range. Also for example, an equipment lease may require that a given one of the leased tractor(s) 414 avoid entering a state or region-such as California, to avoid the applicability of the AB5 (Assembly Bill 5) law determining the difference between employees and independent contractors. If it is determined, based (at least indirectly) upon the GPS data obtained from that leased tractor, that the leased tractor has entered a prohibited state or region, then in such circumstance a determination will have been made that the leased tractor is outside of its acceptable geographic range.

Further, upon such a determination being made, then at a step 516 the equipment leasing company computer(s) 404 can send one or more alerts that the leased tractor is outside of its acceptable geographic range. Such alert(s) can be communicated for example to one or more of the financial institution computer(s) 202 associated with one or more of the financial institution(s) 102 that is or are providing funding in regard to the leasing of that leased tractor. Also for example, upon such a determination being made, then at the step 516 the equipment leasing company computer(s) 404 can send one or more alerts to one or more of the dispatching company computer(s) 206 so as to cause one or more of those computers to send out additional notifications, for example, to that one of the lessee computer(s) 408 that is associated with the lessee of the leased tractor that is outside its acceptable geographic range, requesting (or demanding) that the leased tractor be brought back to an appropriate location. Further for example, upon such a determination being made, then at the step 516 the equipment leasing company computer(s) 404 can directly send one or more alerts for receipt by one or more of the lessee computer(s) 408 associated with the lessee of the leased tractor that is outside its acceptable geographic range, requesting (or demanding) that the leased tractor be brought back to an appropriate location. Also for example, in some embodiments, the equipment leasing company computer(s) 404 can send signals to the leased tractor that is outside its acceptable geographic range causing a light to be illuminated on the dashboard of the vehicle indicating that the leased tractor is outside of its acceptable geographic zone. Additionally for example, upon such a determination being made, then at the step 516 the equipment leasing company computer(s) 404 can send one or more alerts to one or more other recipients, such as one or more of the other computer(s) 412, which (for example) may notify law enforcement that a leased tractor may have been stolen.

In the present example, upon the completion of the step 516, or if at the step 514 it is not determined that any leased tractor is outside of its acceptable geographic range, then the method advances to a step 518. At the step 518, a determination is made by the equipment leasing company computer(s) 404 as to whether there is any one or more of the leased tractor(s) 414 for which maintenance is due soon (e.g., within the coming 24 hours, or week or month) or is past due. Further as shown, if a determination is made at the step 518 with respect to any of the leased tractor(s) 414 that maintenance is due soon, but not yet past due, then the method advances to a step 520. At the step 520, the equipment leasing company computer(s) 404 can send one or more notifications directly for receipt by one or more of the lessee computer(s) 408 associated with the lessee(s) 108 of the leased tractor(s) 414 for which maintenance is due soon in which the notifications remind the lessee(s) of the maintenance obligations and/or direct the lessee(s) to take action in the immediate future. In some embodiments, the notifications can also include recommendations as to where the appropriate maintenance can be performed and how to go about scheduling such maintenance with an appropriate servicing company (e.g., the servicing company 114).

Also as shown, if a determination is made at the step 518 with respect to any of the leased tractor(s) 414 that maintenance is past due, then the method advances to a step 522. At the step 522, the equipment leasing company computer(s) 404 can send one or more alerts to one or more of the dispatching company computer(s) 206 that are associated with the dispatching company (or companies) from which the leased tractor(s) 414 that are overdue for maintenance have been leased. Such alerts can notify the dispatching company computer(s) 206 for example that maintenance is past due, provide the identity or identities of the leased tractor(s) 414 that are overdue for maintenance, specify the type(s) of maintenance that are required, and/or provide other information/data.

Additionally at the step 522, the equipment leasing company computer(s) 404 can send one or more alerts to one or more of the servicing company computer(s) 210 that are associated with one or more of the servicing companies (e.g., the servicing company 114) that are able to provide the required maintenance. Such servicing companies can be, for example, servicing companies that are determined by the equipment leasing company computer(s) 404 as being ones that have previously serviced the leased tractor(s) 414 for which maintenance is overdue, or ones having service facilities that are geographically close to the current location(s) of the leased tractor(s) 414 for which maintenance is overdue. In some embodiments, the equipment leasing company computer(s) 404 at the step 522 can also send one or more notifications directly for receipt by one or more of the lessee computer(s) 408 associated with the lessee(s) 108 of the leased tractor(s) 414 for which maintenance is overdue, or send signals for receipt by those leased tractor(s) causing maintenance due warning lights to become illuminated on the dashboards of those tractors.

Further, although not shown in FIG. 5, in some embodiments, one or more of the servicing company computer(s) 210 can be programmed to operate in accordance with an application or app providing a user interface by which employees (e.g., technicians) of one or more of the servicing companies 114 can input service/maintenance information/data when maintenance is being (or has been) performed. Such service/maintenance information/data, when input into the servicing company computer(s) 210, can be communicated to the equipment leasing company computer(s) 404 associated with the equipment leasing companies 104 that have leased the tractors 414 in regard to which the service/maintenance is being (or has been) performed. Additionally, in some such embodiments, such service/maintenance information/data can be uploaded by the servicing company computer(s) 210 to one or more of the other computer(s) 412, such as the second (e.g., Trimble) cloud server 446, which can in turn provide that information/data to (or allow for accessing of that information/data by) the equipment leasing company computer(s) 404.

Further, upon the completion of either the step 520 or the step 522, or if at the step 518 it is not determined that there are not any of the leased tractor(s) 414 that are overdue for maintenance or will be needing maintenance soon, then the method advances to a step 524. At the step 524, a determination is made by the equipment leasing company computer(s) 404 as to whether there are any one or more of the leased tractor(s) 414 that are failing to meet (or have failed to meet) any other requirements set forth in the leasing agreement(s) and/or servicing agreement(s) pertaining to those leased tractor(s). Such other requirements can include any of a variety of types of requirements including, for example, financial requirements. Further for example in this regard, it can be determined at the step 524 whether one or more lease payments pertaining to any of the leased tractor(s) 414 have not been made on time/are missing, whether the DSCR is too low for any of the leased tractor(s), whether the LTV ratio is at an undesirable level in regard to any of the leased tractor(s), or whether adequate insurance is not in force in regard to any of the leased tractor(s).

If a determination is made at the step 524 with respect to any of the leased tractor(s) 414 that one or more other requirements set forth in the pertinent leasing agreement(s) and/or servicing agreement(s) are not being (or have not been) met, then the method advances to a step 526. At the step 526, the equipment leasing company computer(s) 404 can send one or more alert(s) (or notification(s)) and/or take one or more additional action(s).

For example, in some embodiments, the equipment leasing company computer(s) 404 at the step 526 can send out one or more signals for receipt by the leased tractor(s) 414 that control or affect the operational performance of the leased tractor(s). For example, signals can be sent by the equipment leasing company computer(s) 404 for receipt by the leased tractor(s) 414 that will cause messages to be displayed on the dashboards of the leased tractor(s) informing the drivers of the leased tractor(s) of requirements that need to be met. Also for example, signals can be sent by the equipment leasing company computer(s) 404 for receipt by the leased tractor(s) 414 that will cause the leased tractor(s) 414 to prevent the leased tractor(s) to be turned on after being turned off (e.g., signals resulting in the engine(s) of the leased tractor(s) remaining off after being switched off). In this manner, the equipment leasing company computer(s) 414 can avoid circumstances in which a leased tractor continues to be driven when it is out of compliance with a requirement of the leasing agreement or servicing agreement pertaining to that leased tractor.

In the present example, upon the completion of the step 526, or if at the step 524 it is determined that none of the leased tractor(s) 414 are failing to meet (or have failed to meet) any other requirements set forth in the leasing agreement(s) and/or servicing agreement(s) pertaining to those leased tractor(s), then the method advances to a step 528. At the step 528, a determination is made by the equipment leasing company computer(s) 404 as to whether there have been any request(s) for information/data received by the equipment leasing company computer(s), such as from any financial institution computer(s) 202, dispatching company computer(s) 206, lessee computer(s) 408 (or 208), servicing company computer(s) 210, or other computer(s) 412 (or 212), or even by one or more of the leased tractor(s) 414 (or 214) or component(s) thereof. In some embodiments, it can be the front end server 423 of one of the equipment leasing company computer(s) 404 that receives request(s) for information/data, from one or more other computer(s) that are operating as clients relative to that front end server.

If any request(s) for information/data have been received by the equipment leasing company computer(s) 404, then the method advances to a step 530. At the step 530, the equipment leasing company computer(s) 404 that received the request(s) at the step 528 determine whether the request(s) for information/data is or are proper, or can be properly responded to (e.g., whether the requesting computer(s) is or are authorized to receive the requested information/data). If the request(s) for information/data are proper, or can be properly responded to, then the equipment leasing company computer(s) 404 send signal(s) for receipt by the requesting computer(s) that provide the requested information/data or another appropriate response, such as a request for clarification regarding the request(s) being made. The information/data that is provided can vary depending upon the embodiment or circumstance. Then, upon completion of the step 530, or if it was determined at the step 528 that no request(s) for information/data have been received, then the method ends at an end step 532.

Further with respect to the steps 528 and 530, it should be recognized that, depending upon the embodiment, any of a variety of searches can be performed with respect to the information/data stored in the database 220, in response to requests received at the step 528. For example, the information/data stored in the database 220 can be searched by any of a variety of data types or categories, such as by vendor or manufacturer, by financial institution (or financier), by lessee, or by year of purchase (of the leased tractor(s) 414). For example, if a search request was received at the step 528 by one of the equipment leasing company computers 404 from an appropriate one of the financial institution computers 202 inquiring about leased tractors that are manufactured by Peterbilt Motors Company of Denton Texas and first purchased in 2019 from a particular vendor, then the equipment leasing company computer (assuming that the inquiring financial institution computer was authorized to be provided with such information) could search for such information/data in the database 220 and then send a response containing that information/data for receipt by the inquiring financial institution computer at the step 530.

Also, in some embodiments or circumstances, additional information/data can be generated, determined, or calculated in response to request received at the step 528. For example, such additional information/data can be generated, determined, or calculated at least in part by processing (or further processing) performed by the equipment leasing company computer(s) 404 and/or other computer(s). Such processing can be performed (e.g., as part of the step 530) in accordance with any of a variety of computer programs or code programmed by way of any one or more of a variety of different programming language(s) and/or that, in at least some embodiments, employ or implement any one or more of a variety of algorithms or processing or calculation rules, methods or techniques. For example, in some embodiments, the equipment leasing company computer(s) 404 by such processing are able to generate and provide information that is of interest to various parties such as financial institutions or dispatching companies, such as information regarding unseated time, repair and maintenance downtime, and recruiting turnover concerning one or more leased tractor-trailers, or information that can facilitate a financing company's own Federal Reserve borrowing and/or fractionalization of commercial paper created by the lease financing activity.

In some embodiments, it can particularly be the front end server 423 of one (or more) of the equipment leasing company computer(s) 404 that intercommunicates at the step 530 with the requesting computer(s), which can be client computer(s). For example, in some embodiments, a user employed by or associated with one of the financial institutions 102 can control one of the financial institution computer(s) 202 to access a website hosted by the front end server 423 of one of the equipment leasing company computer(s) 404 and, upon accessing the website, can click on a button or select an option from a web page of the website that causes a signal to be sent to the front end server 423 requesting that a financial report be provided. In response to receiving a signal concerning such a request at the front end server 423, the equipment leasing company computer hosting the website (by itself or with the assistance of other computers) can obtain information/data at that moment and provide the requested report back to the financial institution computer, such that the user (or financial institution) can then utilize the report information as the user sees fit.

Further, in at least some embodiments, the performing of a search and/or obtaining of data (including possible processing as described above) and communicating of that data to another computer (or associated party) at the step 530, which occurs in response to an inquiry received from that other computer (or associated party) at the step 528, can occur instantly or effectively instantly. Also, the information/data that is obtained and communicated can be real time (or effectively real time) data. Thus, a party submitting a request for a report that is received at the step 528 can be provided with a responsive report at least on the same day as the report was requested, and often on a much quicker basis than that, and the information/data included in the report can be highly up-to-date. Such swift operation can be valuable in many contexts. For example, it is important for banks to have current, up-to-date information regarding leases to be available for examination when bank examiners arrive at the banks and select loans for review. Bank examiners for example may seek detailed information about the current locations of all leased tractors that are leased by the bank. The system 400, operating in accordance with the steps 528 and 530, can quickly provide up-to-date reports to a bank in response to an inquiry from a bank (for example, regarding the current position of each of the leased tractors leased by the bank) and thereby enable the bank to address bank examiner questions on effectively a moment's notice and satisfy the bank's compliance obligations.

In the present embodiment, it should be appreciated that the method represented by the flow chart 500 of FIG. 5, and/or one or more individual steps thereof, can be repeatedly performed. For example, the method can begin again at the start step 502 after being completed at the end step 532. Additionally for example, the processing of information/data occurring at the step 510 can be performed repeatedly as additional information/data regarding tractor operation/status is received at the equipment leasing company computer(s). Further, the order of the steps of the flow chart 500 can be modified depending upon the embodiment or operational circumstance. For example, the determinations made at the steps 514 and 518 can be performed in reverse order. Also, two or more of the various steps of the flow chart 500 can be performed simultaneously or concurrently depending upon the embodiment or operational circumstance. Indeed, as described above, in the present embodiment, different ones of the steps of the flow chart 500 are performed by different ones of the computers of the system 400 (or system 200). Therefore, also for example, the accumulating of information/data that occurs at the step 504 can be occurring simultaneously when the equipment leasing company computer(s) 404 are receiving requests for information/data as represented by the step 528.

One or more of the embodiments described or encompassed herein are advantageous in any one or more respects depending upon the embodiment. For example, at least some embodiments are advantageous in that those embodiments utilize GPS location data or tracking information/data not only for the purposes of allowing a carrier to comply with the hours of service and/or ELD requirements (e.g., as set by the Federal Motor Carrier Safety Administration (FMCSA)), to track loads or monitor drivers' hours of service, but also to determine whether leased tractor(s) are in (or can attain or remain in) compliance with a financial institution or a debtor/creditor relationship or agreement such as a leasing agreement and/or servicing agreement. By implementing at least some embodiments described or encompassed herein, it becomes possible to achieve more consistent compliance with leasing and/or servicing agreements for tractors, and it becomes possible to enable financial institutions and other parties that are funding or otherwise involved with tractor leasing (and/or servicing) arrangements to more effectively work with one another as well as satisfy any government regulatory requirements pertaining to such leases.

Further in this regard, some such embodiments encompassed herein are significantly more efficient, accurate, and rapid in operation than conventional systems or methods of providing information regarding leased tractors to financial institutions or determining compliance with obligations set forth in tractor leasing and/or servicing agreements. Indeed, at least some conventional methods of providing financial institutions with information/data regarding leased tractors are simply methods in which representatives of equipment leasing companies receive and respond manually to email messages from representatives of the financial institutions containing various inquires (e.g., inquiries as to the locations of all of the relevant leased tractor(s) on a given day). Such conventional methods of communicating information of interest to the financial institutions can suffer from human data entry concerns (e.g., incorrect longitude/latitude numbers being entered for tractor location) and/or latency concerns. For example, by the time an equipment leasing company representative (or borrower) is able to manually access an electronic database (or consult an ELD system) to obtain, and communicate to, a financial institution information regarding the location of a leased tractor, the leased tractor may have been driven to another location such that the information relayed to the financial institution is no longer accurate. Further, obtaining, assembly, and communicating information desired by the financial institution in this manner, in accordance with conventional methods, sometimes can take a day (or two).

By comparison, at least some embodiments herein make it possible to obtain and accumulate in a centralized repository (e.g., equipment leasing company computer(s)), automatically on a real-time or frequent periodic basis and in an accurate and rapid (or timely) manner, any of a variety of types of information/data regarding leased tractors. The information/data that is obtained and collected can include, for example, operation/status (including ELD) information/data, as can be collected via tractor ECUs (or engine control modules (ECMs) or other devices or via cloud servers and associated services (such as that provided by Samsara or Trimble), as well as information/data regarding leasing payments and the status/performance of leasing arrangements or lessee(s).

At least some such embodiments encompassed herein advantageously make it possible to assemble and provide reports or other information/data (whether generated after further processing or not) in an efficient, accurate, frequent, and/or rapid manner to financial institutions, dispatching companies, servicing companies, lessee(s), and/or other entities that are seeking such reports or other information/data, as well as can facilitate the meeting of regulatory requirements by the parties involved with tractor leasing. Indeed, such embodiments can also facilitate the implementation of lease financing arrangements by enabling enhanced monitoring of tractor operations and statuses and verification of tractor and lessee compliance with requirements of the lease financing arrangements. Additionally, such embodiments can allow for actions to be taken that enhance the utilization of leased tractors at any given time and also over the lifespan of those leased tractors, as well as achieve better compliance with the requirements of lease financing arrangements and relevant governmental regulations.

It is specifically intended that the present invention not be limited to the embodiments and illustrations contained herein, but include modified forms of those embodiments including portions of the embodiments and combinations of elements of different embodiments as come within the scope of the following claims.

What is claimed is:

1. A tractor operation or status monitoring and alert system suited for facilitating lease financing of tractors for tractor-trailers, the system comprising:
at least one equipment leasing company computer including a front end server, a back end server, and a database;
a first financial institution computer;
a dispatching company computer;
a lessee computer including a mobile device or a desktop or laptop computer;
a servicing company computer;
an additional computer including at least one cloud server; and
one or more wired or wireless communication links by which the at least one equipment leasing company computer is at least indirectly in communication with each of the financial institution computer, the dispatching company computer, the lessee computer, the servicing company computer, and the additional computer,
wherein the at least one equipment leasing company computer is configured to:
receive first information regarding either an operation or a status of a first leased tractor at the database, the first information being received from the at least one cloud server and based at least indirectly upon second information obtained one or more sensing devices supported on or associated with a first leased tractor:
perform first processing in regard to the first information to generate first processed information that includes a first report regarding the first leased tractor;
send the first report for receipt by the first financial institution computer;
determine, at least in part based upon the first information, the second information, or third information, whether the first leased tractor has failed to meet a first requirement of a first agreement pertaining to the lease financing of the first leased tractor; and,
if it is determined that the first leased tractor has failed to meet the first requirement, send at least one alert or notification for receipt by one or more of the first financial institution computer, a second financial institution computer, the dispatching company computer, the lessee computer, the servicing company computer, or the additional computer.

2. The system of claim 1, wherein the front end server of the at least one equipment leasing company computer is configured to receive and respond to client inquiries from one or more of the first financial institution computer, the dispatching company computer, or the lessee computer.

3. The system of claim 1, wherein the one or more wired or wireless communication links facilitate internet-based communications between the at least one equipment leasing company computer and each of the financial institution computer, the dispatching company computer, the lessee computer, the servicing company computer, and the additional computer.

4. The system of claim 1, wherein the first information regarding either the operation or the status of the first leased tractor relates to a location of the first leased tractor and is based upon at least a portion of the second information obtained by a global positioning system (GPS) sensing device.

5. The system of claim 1, wherein the first information regarding either the operation or the status of the first leased tractor is based upon at least a portion of the second information obtained by an odometer sensing device.

6. The system of claim 1, wherein the at least one cloud server includes one or both of a Samsara cloud server or a Trimble cloud server, wherein the database is at least partly formed as part of one or both of the front end server and the back end server, and wherein the at least one equipment leasing company computer is formed at least in part as a cloud-based computer system.

7. The system of claim 1, wherein the first requirement relates to whether a location of the first leased tractor is within or not within a prescribed region, whether a maintenance operation regarding the first leased tractor will soon be due or is past due, or whether a financial or insurance obligation related to the lease financing of the first leased tractor has been satisfied.

8. The system of claim 7 wherein, if it is determined that the first leased tractor has failed to meet the first requirement and the first requirement relates to whether the first leased tractor is within or not within the prescribed region, then the sending of the at least one alert or notification includes a first sending of a first alert to one or more of the first financial institution computer, the second financial institution computer, the dispatching company computer, or the lessee computer.

9. The system of claim 7 wherein, if it is determined that the first leased tractor has failed to meet the first requirement and the first requirement relates to whether the maintenance operation regarding the first leased tractor will soon be due or is past due, then the sending of the at least one alert or notification includes a first sending of a first notification to one or more of the dispatching company computer, the servicing company computer, or the lessee computer.

10. The system of claim 7 wherein, if it is determined that the first leased tractor has failed to meet the first requirement and the first requirement relates to whether a financial or insurance obligation related to the lease financing of the first leased tractor has been satisfied, then the sending of the at least one alert or notification includes a first sending of a first alert to one or more of the first financial institution computer and the second financial institution computer.

11. The system of claim 10, wherein the first requirement relates to whether a lease payment has been missed, or whether a debt service coverage ratio or a loan to value (LTV) ratio is at an undesirable level.

12. The system of claim 1, wherein the first report includes additional information indicative of historic operations of the first leased tractor both during a current time period when the first leased tractor has been leased by a first lessee associated with the lessee computer, and during a prior time period when the first leased tractor had been leased by one or more prior lessees.

13. The system of claim 1, wherein the at least one equipment leasing company computer additionally is configured to generate and send, for receipt by the first financial institution computer, additional reports on a periodic basis.

14. A tractor operation or status monitoring and alert system suited for facilitating lease financing, the system comprising:
at least one equipment leasing company computer including a front end server, a back end server, and a database,
wherein the at least one equipment leasing company computer is configured to engage in internet-based communications with a plurality of other computers including each of a first financial institution computer, a dispatching company computer, a lessee computer, a servicing company computer, and an additional computer including at least one cloud server, and
wherein the at least one equipment leasing company computer is programmed to operate in accordance with software so that the at least one equipment leasing company computer is configured to:
receive first information regarding operations or statuses of a plurality of leased tractors including a first leased tractor and a second leased tractor by engaging as a client in communications with the at least one cloud server;
store the first information in the database, the first information being received from the at least one cloud server and based at least indirectly upon second information obtained by sensing devices and engine control units (ECUs) supported on or associated with the first and second leased tractors with which the at least one cloud server is at least indirectly in communication;
perform first processing in regard to the first information to generate first processed information that includes a first report regarding the first leased tractor and a second report regarding the second leased tractor;
send the first and second reports for receipt by the first financial institution computer;
determine, at least in part based upon the first information or second information, whether the first leased tractor has failed to meet a first requirement of a first agreement pertaining to the lease financing of the first leased tractor; and,
if it is determined that the first leased tractor has failed to meet the first requirement, send at least one alert or notification for receipt by one or more of the first financial institution computer, a second financial institution computer, the dispatching company computer, the lessee computer, the servicing company computer, or the additional computer.

15. A tractor operation or status monitoring and alert method for facilitating lease financing of tractors for tractor-trailers, the method comprising:
providing at least one equipment leasing company computer including a front end server, a back end server, and a database,
wherein the at least one equipment leasing company computer is configured to engage in communications with a plurality of other computers including each of a first financial institution computer, a dispatching company computer, a lessee computer, a servicing company computer, and an additional computer including at least one cloud server;
receiving first information at the at least one equipment leasing company computer regarding either an operation or a status of a first leased tractor at the database, wherein the first information is received from the at least one cloud server and is based at least indirectly upon second information obtained by a sensing device or engine control unit (ECU) supported on or associated with a first leased tractor;
performing first processing in regard to the first information to generate first processed information that includes a first report regarding the first leased tractor;
sending the first report for receipt by the financial institution computer;
determining at the at least one equipment leasing company computer, at least in part based upon the first information or second information, whether the first leased tractor has failed to meet a first requirement of a first agreement pertaining to the lease financing of the first leased tractor,
wherein the first requirement relates to whether a location of the first leased tractor is within or not within a prescribed region, whether a maintenance operation regarding the first leased tractor will soon be due or is past due, or whether a financial or insurance obligation related to the lease financing of the first leased tractor has been satisfied; and
if it is determined that the first leased tractor has failed to meet the first requirement, then sending at least one alert or notification for receipt by one or more of the first financial institution computer, a second financial institution computer, the dispatching company computer, the lessee computer, the servicing company computer, or the additional computer.

16. The method of claim 15, wherein either the second information includes global positioning system (GPS) information and the sensing device is a GPS sensor, or the second information includes odometer information and the sensing device is an odometer.

17. The method of claim 15,
wherein the first information received at the at least one equipment leasing company computer is stored in the database after being routed through the back end server, and
wherein the first information is stored along with historically-obtained information, the historically-obtained information including at least some further information concerning a prior operation or a prior status of the first leased tractor when the first leased tractor was leased by a prior lessee differing from a current lessee to whom the first leased tractor is currently being leased.

18. The method of claim 1, further comprising, in addition to the sending of the first report, periodically sending additional reports also regarding the first leased tractor.

19. The method of claim 1, further comprising:
receiving, at the front end server of the at least one equipment leasing company computer, an inquiry signal concerning a request for additional information from a further computer system or entity; and
upon determining that the request can be properly answered, sending a response signal for receipt by the further computer system or entity.

20. The method of claim 1, further comprising:
taking a further action upon it being determined that the first leased tractor has failed to meet the first requirement or upon it being determined that either the first leased tractor or a second leased tractor has failed to meet a second requirement, the further action including further sending at least one additional alert, notification, or control signal for receipt by at least one of the financial institution computer, the dispatching company computer, the lessee computer, or either the first leased tractor or the second leased tractor.
